(19) United States
(12) Patent Application Publication
(10) Pub. No.: US 2014/0200976 A1
(43) Pub. Date: Jul. 17, 2014

(54) Transferable Indicia and Display

(71) Applicants: Merrill Brooks Smith, Ft. Lauderdale, FL (US); Phillip Craig Graves, Atlanta, GA (US); Phil M. Chakiris, Atlanta, GA (US); Samuel Collins, Woodstock, GA (US)

(72) Inventors: Merrill Brooks Smith, Ft. Lauderdale, FL (US); Phillip Craig Graves, Atlanta, GA (US); Phil M. Chakiris, Atlanta, GA (US); Samuel Collins, Woodstock, GA (US)

(21) Appl. No.: 13/742,608

(22) Filed: Jan. 16, 2013

(51) Int. Cl. G06Q 30/02

(52) U.S. Cl. CPC G06Q 30/0222
USPC 705/14.23

(57) ABSTRACT

Aspects of the invention may include methods and systems for conducting a transaction utilizing an indicia associated with goods or services, the indicia initially provided to an originating party by an originating merchant, but wherein the indicia may be used in a transaction at a providing merchant by an obtaining party, the transaction conducted amongst a central processor, one or more merchants that may include the originating merchant and the providing merchant, and one or more parties that may include the originating party and the obtaining party. The method may include steps such as: receiving the indicia from the providing merchant; determining whether the indicia is valid, the goods or services associated with the indicia, whether the providing merchant is the originating merchant, whether the obtaining party is the originating party, and determining a transaction price for the indicia.

### RELATED APPLICATIONS

This application claims priority to U.S. Provisional Patent Application No. 61/608,820 filed on Mar. 9, 2012.

### BACKGROUND OF THE INVENTION

Prevalence of stored value cards associated with goods or services ranging from multipurpose reloadable debit cards (open loop or closed loop) and wireless mobile airtime to digital downloads, transit applications, and even the purchase of tangible goods has vastly increased in the past several years. As the use has increased, systems and methods of providing and using such cards has evolved.

Stored value cards may be generally divided into two (2) categories: chip cards and account cards. In a chip card (e.g., a “smart card”), a value account may actually reside on the card itself. In contrast, with an account card, the card may be associated with a value account that may reside elsewhere, for example on a payment processor or in a database of a financial institution. In such situations, the stored value card may comprise an indicia, such as but not limited to an account number, that may be used to conduct card transactions such as activation, redemption, reloading, recharging, etc.

However, the necessity or usefulness of the physical card itself (or any such tangible medium comprising the information required to access an underlying stored value account) may be greatly diminished as the use of digital devices (such as, but not limited to, mobile telephones and devices, tablets, laptop and other computers, electronic readers such as the Nook™ and Kindle™) increases.

As the necessity, usefulness, or even desirability of physical cards decrease, the indicia associated with the underlying value account may become more important. Accordingly, an indicia that is transferable while being associated with a stored value account may be desirable.

### SUMMARY OF THE INVENTION

Aspects of the invention may include a method of conducting a transaction utilizing an indicia associated with goods or services, the indicia initially provided to an originating party by an originating merchant, but wherein the indicia may be used in a transaction at a providing merchant by an obtaining party, the transaction conducted amongst a central processor, one or more merchants that may include the originating merchant and the providing merchant, and one or more parties that may include the originating party and the obtaining party, the method comprising: receiving at the central processor the indicia from the providing merchant; determining by the central processor: whether the indicia is valid; and the goods or services associated with the indicia; determining by the central processor whether the providing merchant is the originating merchant, and upon a determination that the providing merchant is not the originating merchant, determining an appropriate transaction price for the indicia; determining by the central processor whether the obtaining party is the originating party, and upon a determination that the obtaining party is not the originating party, determining if the transaction price for the indicia should be modified; and communicating between the central processor and the providing merchant a final transaction price for the indicia.

Other aspects of invention may include a method of conducting a transaction utilizing an indicia associated with goods or services, the indicia initially provided to an originating party by an originating merchant, but wherein the indicia may be used in a transaction at a providing merchant by an obtaining party, the transaction conducted amongst a central processor, one or more merchants that may include the originating merchant and the providing merchant, and one or more parties that may include the originating party and the obtaining party, the method comprising: capturing the indicia at the point of sale by the providing merchant; determining if the indicia is accepted by the providing merchant, and upon a determination that the indicia is not accepted by the providing merchant, terminating the transaction; upon a determination that the indicia is accepted by the providing merchant, communicating the indicia to the central processor; receiving from the central processor a transaction price for the indicia.

Other aspects of the invention may include a system for conducting a transaction utilizing an indicia associated with goods or services, the system comprising: a central processor; an originating merchant, the originating merchant providing the indicia to an originating party; an originating party, the originating party obtaining the indicia from the originating merchant; a providing merchant, the providing merchant providing either an activated indicia or the goods or services associated with the indicia to the obtaining party, the providing merchant being in selective communication with the central processor; an obtaining party, the obtaining party conducting the transaction with the providing merchant and obtaining either an activated indicia or the goods or services from the providing merchant.

These and other aspects will become apparent from the following description of the invention taken in conjunction with the following drawings, although variations and modifications may be effected without departing from the spirit and scope of the novel concepts of the invention.

### DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary display in accordance with some embodiments of the invention.

FIG. 2 illustrates an exemplary display in accordance with some embodiments of the invention.

FIG. 3 illustrates an exemplary display with exemplary indicia in accordance with some embodiments of the invention.

FIG. 4 illustrates a general transaction flow in accordance with some embodiments of the invention.

FIG. 5 illustrates various display communication or updating methods in accordance with some embodiments of the invention.

FIG. 6 illustrates a general transaction flow in accordance with some embodiments of the invention.

FIG. 7 illustrates a table that sets forth an exemplary commissioning schedule in accordance with some embodiments of the invention.

FIG. 8A-8D illustrates systems and methods of transferring one or more indicia among one or more users, in accordance with some embodiments of the present invention.

FIGS. 9A-9B illustrate systems and methods of transferring one or more indicia among one or more users, in accordance with some embodiments of the present invention.

FIG. 10 illustrates systems and methods of transferring one or more indicia among an organization and one or more users, in accordance with some embodiments of the present invention.

FIG. 11 illustrates systems and methods of transferring one or more indicia in a business-to-business environment, in accordance with some embodiments of the present invention.

FIG. 12 illustrates systems and methods of transferring one or more indicia identified by an interested party among one or more users, in accordance with some embodiments of the present invention.

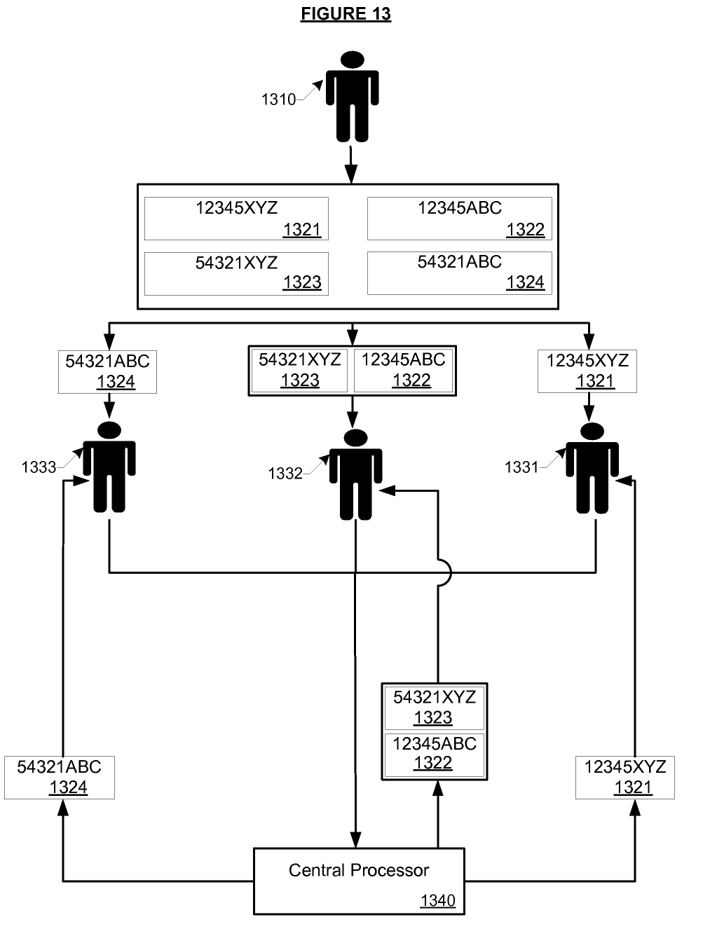

FIG. 13 illustrates systems and methods of transferring one or more active indicia among one or more users, in accordance with some embodiments of the present invention.

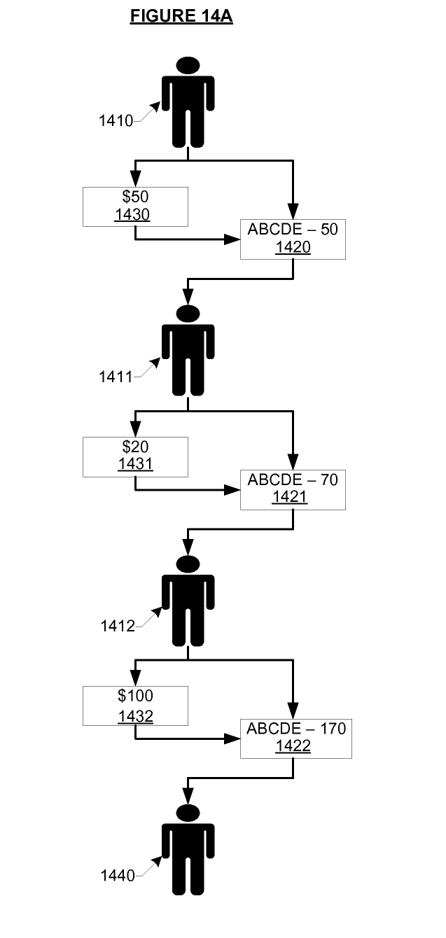

FIG. 14A and 14B illustrate systems and methods of transferring one or more indicia among one or more users in a group gifting environment, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

This application is directed, in general, to systems, methods, and computer readable mediums for advertising, tracking, processing, activating, authorizing, and providing goods or services to a customer, including commissioning based thereon. More specifically, the present invention is directed to various aspects, systems, components, and methodologies related to at least one or more of:

(i) displaying to a customer various goods or services at a retail location;

(ii) providing to customer an indicia of the goods or services;

(iii) the customer or originating party, being enabled to capture or save the indicia in a device, for example a mobile telephone, tablet, or computer;

(iv) the originating party being enabled to maintain the indicia in an intermediate state before purchase on or in the device;

(v) the indicia being transferrable such that, for example, (a) the originating party may be capable of sending the indicia—or an identifier associated with the indicia—to another party who may pay for the goods or services, the paying party; (b) the originating party may be capable of paying for the indicia and sending the goods or service to another party, the receiving party; and/or (c) any other transferability that may be evidenced by and between an originating party, paying party, and receiving party—whom may each be the same or different users.

(vi) the indicia being usable to purchase and/or activate and/or authorize the goods or service;

(vii) the indicia may comprise various piece of information, or may created by combining different pieces of information. The indicia may evolve as it is transferred between and amongst the various parties and retailers, and may at any point identify or be associated with one or more of (a) the specific goods or services; (b) the originating retailer; (c) the originating party; (d) the purchasing party; (e) the receiving party; (f) the providing retailer; (g) pricing related to the specific goods or services; and/or (h) any promotions, rebates, customer loyalty membership, coupons, or other programs or plans that may impact the pricing of the goods or services.

(viii) in the case of electronic or digital goods or services, the goods or services may actually be placed or downloaded onto the device at the originating retailer, but may be locked—thereby preventing use—until the goods or services are purchased.

(ix) the goods or services may be purchased (a) at the originating retailer (for example, through a typical in-lane transaction at a point of sale (POS)); (b) by visiting the originating retailer's website or other online or electronic presence; (c) through an application (or “app”) on the device, wherein the app may be associated or provided by the originating retailer, a third party, or even a competing retailer; (d) by visiting a third party or competitor retailer's location and completing the purchase through a typical in-lane transaction at a POS; (e) by visiting a third party or competitor retailer's website or other online or electronic presence.

(x) When the goods or services are purchased, the originating retailer may receive commission payments, the commission payments may vary depending on how and from whom the purchase transaction occurred. For example, if the indicia is used to purchase the goods or services at the originating retailer during a typical in-lane transaction at a POS or through an app or online presence provided by or managed for the originating retailer, the originating retailer may receive full commission, for example 100×. If the indicia is used to purchase the goods or services at a later time, for example through a third party application or online presence, the originating retailer may receive either full commission (100×) or a slightly reduced commission (75×). If the indicia is used to purchase the goods or services at a later time and through a competing retailer—either in-lane or through a competing retailer's application or online presence, the originating retailer may receive a reduced commission, for example 50×, while the competing retailer—now the providing retailer—if it participates in the overall program, may receive a commission of 50×.

(xi) The commissions of the originating and/or providing retailers may vary based upon various promotions associated with the goods or services. For example, an originating retailer may attempt to increase its chances at being the providing retailer by reducing the overall price of the goods or services—thereby reducing its commission. For example, if an originating retailer receives a commission of 50× for initially conveying the indicia to the customer—even if purchased at a competitor retailer—the originating retailer may reduce the price of the goods or services by 25×, thereby potentially increasing its chances of making the sale and receiving a commission of 75× rather than 50× if it fails to make the sale.

In some embodiments of the present invention, the various indicia may be stored in a basket in the mobile device for later purchase. In such circumstances, it is anticipated that any party with the indicia—the originating party, those who have it on their devices in anticipation of becoming a receiving party or a paying party—may receive various updates or communications regarding promotions directed at the specific or related goods or services.

As briefly noted above, the invention may comprise a user display that may be present at a retailer location. The user display may comprise basic signage, a video display, touch screen, e-ink (e.g., a bi-stable display), an interactive display, one or more screens or multiple screens or display zones, a multimedia display (e.g., with sound, video, tactile, scents, tastes, etc.).

The information that is displayed may be updated in various manners. In the case of basic signage, the display may be updated according to typical manners—that is replacing various signs and displays. In the case of an electronic display (video or otherwise), the information on the display may be updated through the use of a network connection (e.g., internet, T1, T3, cable, fiber-optic, etc.), through mobile technology (e.g., 3G, 4G, etc.), wireless technology (RFID, BlueTooth®, or other wireless technology), or though updatable or replaceable memory (e.g., a disc, memory card, thumb drive, DVD, or other storage device, etc.).

The goods or services may comprise any number of products. For example, stored value cards (e.g., gift cards, prepaid debit cards, etc.), wireless airtime or top-up cards, gaming tokens or value cards, transportation tolls, laundry value, digital media (e.g., music, videos, books, programs, software, games, applications, etc.), services, and/or any other virtual, electronic, digital, or physical goods.

Indicia selected and saved by the originating party may be placed, kept, and/or saved in various wallets, folders, groupings, or baskets associated with the mobile device. Such wallets, folders, groupings, or baskets may be created and managed by the user and may be associated with various characteristics such as originating retailers, categories of goods or services, dates of selection, payment mechanisms, etc. The indicia may be kept in such wallets, folders, groupings or baskets until purchase or until a period of time has elapsed and the indicia expires. Alternatively, if the indicia is associated with goods or services is associated with a specific price or promotion, the indicia may expire or delete when the promotion ends or when the price is no longer available.

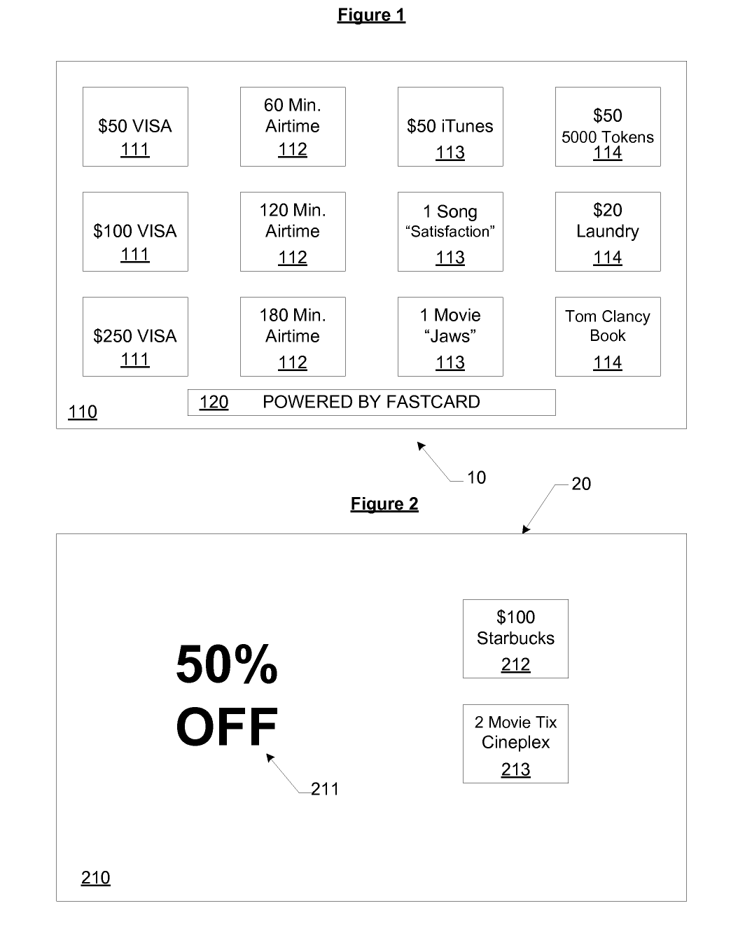

With reference to FIG. 1, an exemplary display 10 in accordance with some embodiments of the invention will now be discussed. Display 10 may be any form of signage, video display, monitor, touch-screen, bi-stable display, etc 110. It may comprise one or more display zones, and may display one or more products. With reference to FIG. 1, display 10 may set forth various products—goods or services—that may be purchased or obtained by using the display. For example, display 10 may set forth financial products 111 (for example, a $50, $100, or $250 Visa card), airtime or mobile phone products 112 (for example, 60 minutes, 120 minutes, or 180 minutes of prepaid airtime), digital media 113 (for example, an iTunes prepaid card, a single song download, or a movie download purchase or rental), or other items 114 (for example, game tokens for online or local gaming, laundry card or value, downloadable books for e-readers, etc.). It is contemplated that any good—either digital, electronic, or physical—may be purchased through the systems and methods of the invention and may be identified by an indicia.

In addition, the indicia can be associated with an amount of value, and the invention may be used to transmit monetary amounts between users. An indicia of value, for example an indicia representative 50 Euros may be selected by an originating party. The originating party may be pay for the 50 Euros in dollars, and then send the indicia to the value to a receiving party. The receiving party may use the indicia sent to obtain the value—50 Euros.

Similarly, an indicia may be circulated amongst a group of users, and each user may add value to the indicia. For example, an originating party may select an indicia associated with a variable denomination Visa prepaid debit card. The originating party may select—and provide payment for $50 to be added onto the associated Visa prepaid debit card. The originating party may then circulate or pass on the indicia to others, who in turn may contribute to the Visa prepaid debit card through the use of the indicia. Once finalized, the indicia may be sent to the receiving party who may receive the cumulative gift.

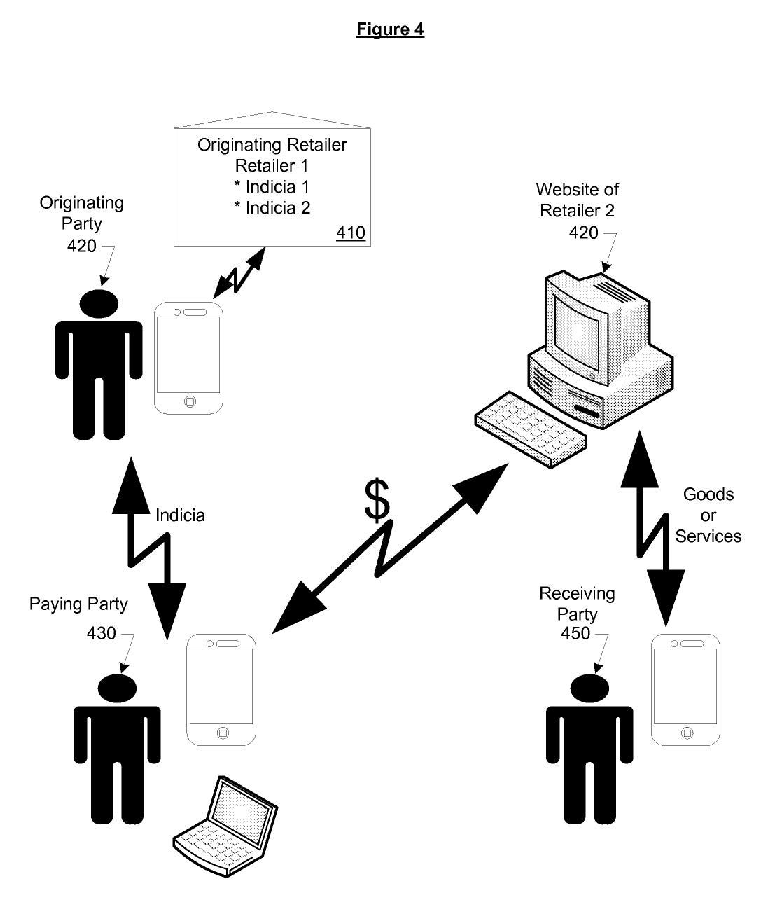

Each of the items 111, 112, 113, 114 displayed in display 10 may be associated with an indicia. The indicia may be available through the use of the display, as discussed in greater detail below with reference to FIG. 3.

Note that display 10 may be provided by a third party, and this may be noted on the display 120. The third party may be an intermediate party between and among the originating retailer, the providing retailer, and/or the provider of goods or services. The third party may establish and manage the systems and methods of the invention.

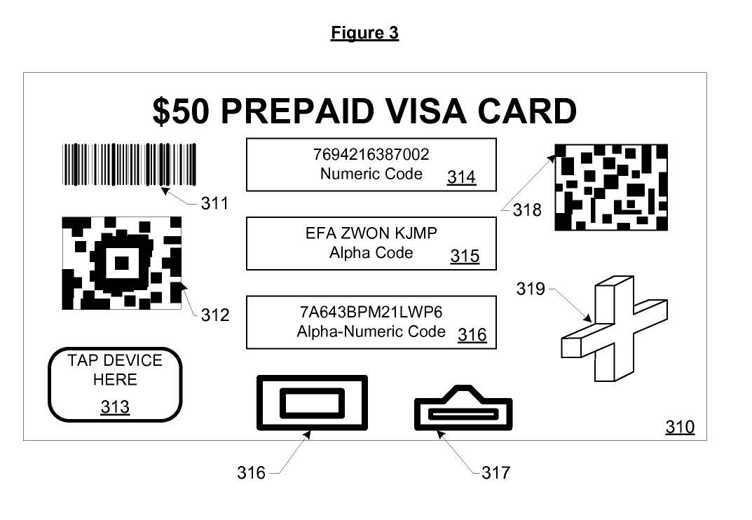

With reference to FIG. 2, a display 20 may also comprise one or more display zones. For example, a display may be broken into two (2) zones, wherein one zone 210 displays various promotions and discounts 211, while the second zone 220 displays the corresponding products 212, 213 for which the promotions or discounts apply. Alternatively, one display zone may provide a video—such as a commercial or other such advertisement—while a second display zone displays the products and corresponding indicia being advertised.

Alternatively, various display zones may be used to display related, complimentary, or associated products. For example, if the display is a touch screen, a user may be able to select a particular product from a digital catalog, separated by, for example, category. Once a user selects a product or category, other related, complimentary, or associated products may be displayed. In such an embodiment, for example, a user may select a product corresponding to movie or theater tickets, and products related to restaurants local to the theater may be displayed.

In some embodiments, comparable products or services may be displayed to the customer along with or in lieu of selected products or services. For example, a customer may be viewing various gift cards that for restaurants. The customer may have selected an Italian restaurant. The display may set forth comparable products—that is, other Italian or similar restaurants—for which the originating retailer can offer current discounts or promotions.

The display may be any sort of device that is capable of conveying to the user or customer indicia associated with desired or selected goods or services. The indicia may be conveyed by a mobile phone reading, or otherwise obtaining the indicia from the display, for example, by reading a machine code. With reference to FIG. 3, the indicia may be listed and displayed as a code (for example, a bar code 311, Aztec code 312, QR code 319, or picture code 319), or may be alpha 315, numeric 314, or alphanumeric 316 code that the user may input into the mobile device. The indicia may be also be wirelessly transmitted to the user device, for example through the use RFID or BlueTooth technology, which may be prompted by “tapping” a particular portion of the display 313. Alternatively, the user may connect the user device directly to the display, for example by way of a USB or mini-USB cable 317.

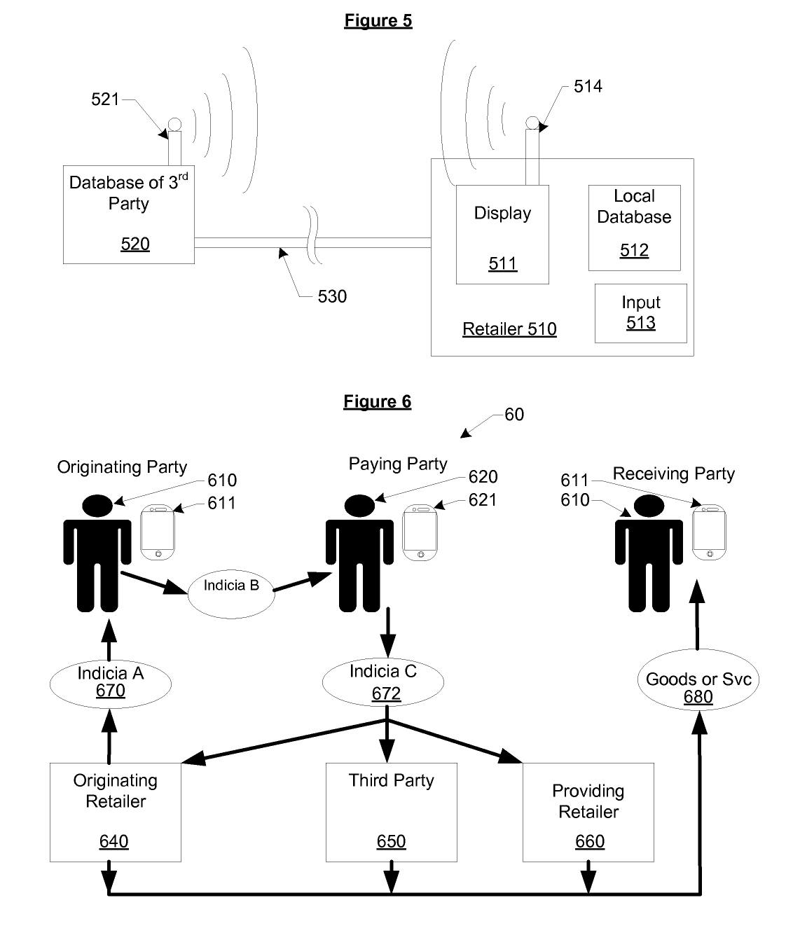

With reference to FIG. 4, a general transaction will now be discussed. An originating retailer 410 may comprise a display, which in turn may comprise various indicia of various goods or services. An originating party 420 may select and save one or more indicia on a device 421. At this point, the originating party may proceed to the retailer checkout point of sale (POS) and pay for the goods or services associated with the indicia. Here, the originating party is also the paying party. Once paid for, the goods or services may be provided—either physically or electronically—to the originating party. Here, the originating party is also the paying party and the receiving party.

Alternatively, the originating party 420 may provide the indicia to a different party—a paying party—who may pay for the goods or services using the indicia. The paying party 430 may utilize a device 431 to pay for the goods or services at the originating retailer 410, at a digital presence of the originating retailer 410, at a different retailer, at a digital presence of a different retailer, or from a third party (for example, a party managing the program). With reference to FIG. 4, in this exemplary embodiment the paying party 430 may utilize the website of a different retailer 440 to purchase the goods or services using the indicia. The different retailer is the providing retailer. Note that the originating retailer and the providing retailer may be the same.

The providing retailer 440 may then provide the purchased goods or services to the desired party. The party that receives the purchased goods or services a receiving party 450, who may receive the goods or services on or associated with another device 451. Note that the receiving party may be the originating or paying party, but need not be.

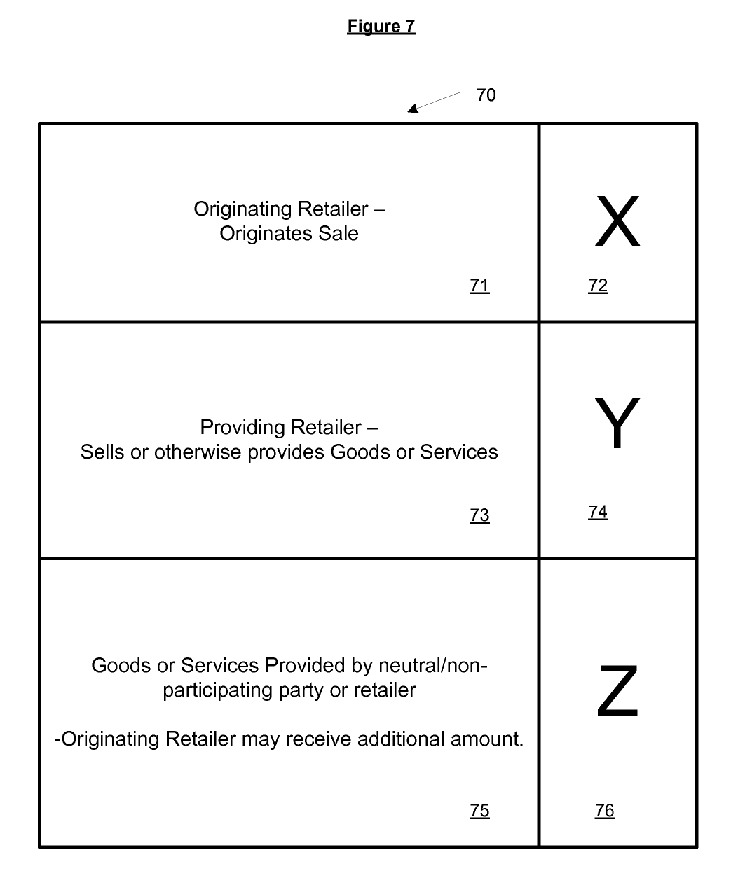

With reference to FIG. 5, various manners of updating a display 511 at a retail location 510 will briefly be discussed. The display 511 may be in selective communication with a local database 512 of various promotions or items. The display 511 may be in selective communication with an input 513—which may receive a memory card, thumb drive, DVD, or any other download of updated information local to the retailer 510. Alternatively, the display 511 may be in selective wireless communication 514 with another party 520 who may remotely update the display using its own wireless communication 521. The display 511 may also be in selective wired communication with the third party 520, for example by way of a network connection (e.g., the internet, a host-to-host connection, a direct line, etc.). It is also anticipated that more than one party may be able to update information on the display 511. For example, a provider may purchase display time and may use such time to display various goods, services, promotions, etc. The provider may accordingly directly update and/or modify its contribution to the display.

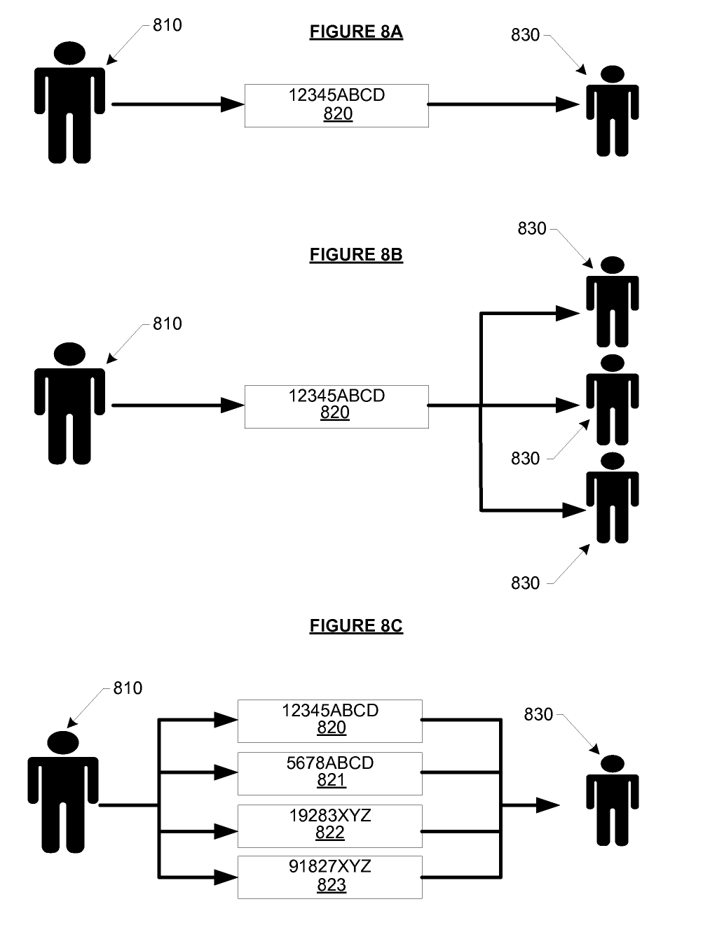

With reference to FIG. 6, a potential flow 60 of the indicia and purchased product or service in accordance with some embodiments of the invention will now be discussed. An originating party 610 may use a device 611 to capture an indicia 670 from an originating retailer 640. The indicia 670 may comprise information such as identifying the product or service, pricing information of the product or service, identifying information of the originating retailer 640, etc.

The originating party 610 may convey the indicia to a paying party 620 (or a paying party's device 621). Note that the indicia 671 conveyed from the originating party 610 to the paying party 620 may be modified from the initial indicia 670 captured at the originating retailer 640. For example, the modified indicia may include information identifying the originating party, various customer loyalty membership information of the originating party, etc. The paying party 620 may use an indicia 672 to purchase the goods or services. The goods or services may be purchased from a providing party—that is, the originating retailer 640, a third party 650, or another retailer who is a providing retailer 660. The indicia 672 provided from the paying party 620 to the providing party may be further modified from indicia 670 or 671. Indicia 672 may comprise information identifying the paying party 620, various memberships of the paying party 620, or information identifying or associated with the party to receive the goods or services—the receiving party 630.

The providing party may then provide the goods or services to the receiving party 630 or a device of the receiving party 631. Again, note that the originating party 610, paying party 620, and receiving party 630 may be the same or different parties or users.

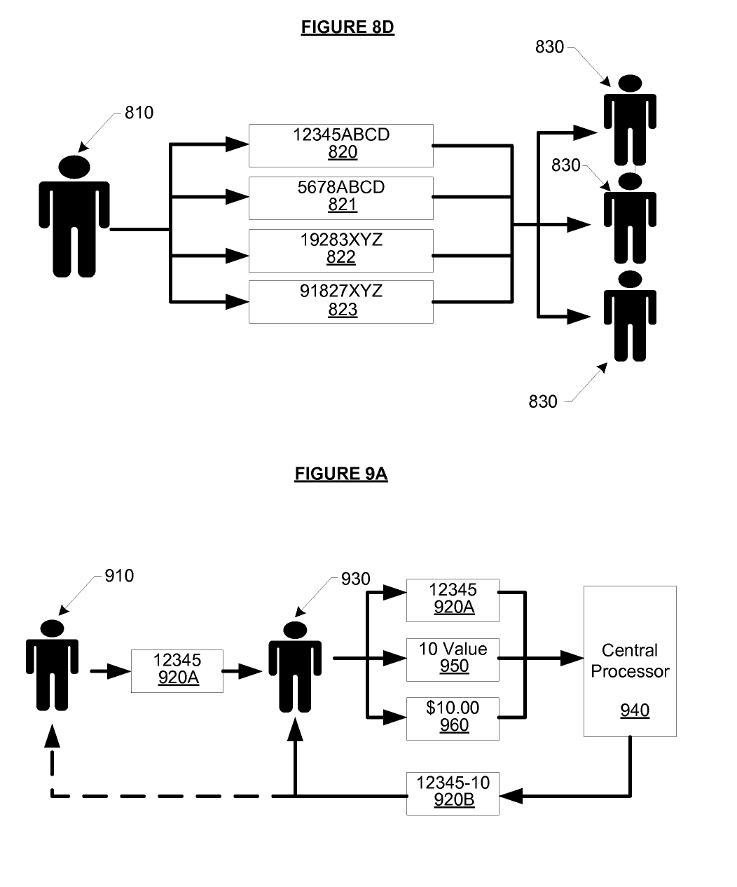

With reference to FIG. 7, an exemplary commissioning schedule 70 based upon various purchase arrangements will now be discussed. For example, because an originating retailer originated the sale—regardless of where the final sale took place—by providing the initial indicia to the customer 71, the originating retailer may be entitled to a commission of X (for example, 1-2% of the value of the product purchased) 72. The providing retailer—assuming that the providing retailer is a participant in the program 73—may receive a commission of Y for consummating the sale 74 (for example, 2-2.5% of the value of the product purchased). If the providing retailer is not a program participant—or if the goods or services were provided from a neutral third party (for example, a third party managing the program) 75, then the originating retailer may be entitled to an additional commission of Z (for example, 0.5% of the value of the product purchased) 76.

Accordingly, if the originating retailer is the providing retailer, then that retailer may be entitled to a commission of 3-4.5% of the purchase price of the product or service. The originating retailer is rewarded for successfully advertising, displaying, and initiating a sale of a product or service. The providing retailer is rewarded for actually closing the sale.

It is anticipated that once an originating party or any other party has saved one or more indicia in a device, it may be able to purchase the associated product or service by selecting the indicia on the device and utilizing an application that may be provided by a retailer or by a third party managing the program. Accordingly, a purchase using an application provided by the program manager or any other neutral third party would not negatively impact the originating retailer's commission, but would rather add a small amount (since a sales commission is not paid to another party).

Such an intermediary application may communicate with the display at the originating merchant to obtain the various indicia and may act as a basket to hold the various indicia that are not yet purchased. The intermediary application may also be in selective communication with a funding source—for example a mobile wallet or financial account—in order to provide easy payment for indicia selected for purchase. Moreover, the intermediary application may contain user information the may impact availability or pricing of various goods or services. For example, a customer may utilize such an intermediary application to record various customer loyalty programs, membership programs that may impact pricing (for example, AAA), membership programs that may impact product or service availability (for example, DirectBuy, or purchases from a club) or other identifying characteristics that may impact product or service availability or pricing. Indicia displayed on the display may be specifically configured for use with such intermediary applications in an attempt to provide quick, efficient, and seamless purchase transactions.

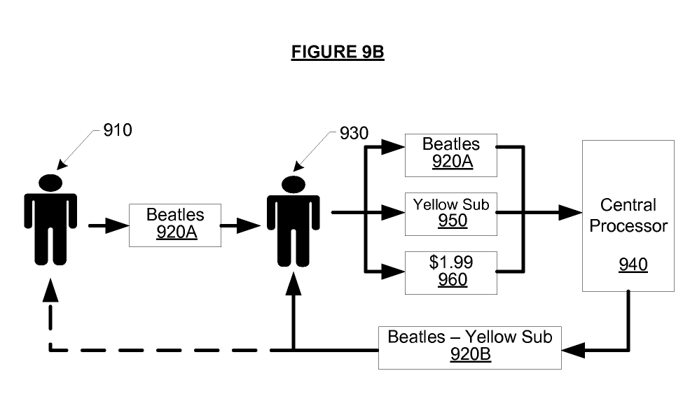

With reference to FIGS. 8A-D, systems and methods of utilizing transferable indicia in accordance with some embodiments of the present invention will now be discussed. With reference to FIG. 8A, it is contemplated by the present invention that an originating party 810 may capture, read, or otherwise obtain one or more indicia 820 of a stored value. The originating party 810 may convey the indicia 820 to a second party 830. Note that the originating party 810 may be the second party 830, and/or the second party 830 may be the paying party and/or the receiving party. The second party 830 may purchase the indicia 820, may pass the indicia 820 onto another party, or may receive the indicia 820 once/if purchased.

With reference to FIG. 8B, an originating party 810 may convey an indicia 820 to more than one party 830, 831, 832. In this embodiment, one or more of parties 830, 831, 832 may be the paying, or receiving party. For example, an originating party 810 may wish to either receive a certain indicia and may send to the indicia to various potential gift-givers. In accordance with some embodiments, an originating party 810 may wish for each of the parties 830, 831, 832 to obtain and receive the indicia—for example, if the indicia is indicative of a text book at a reduced price.

With reference to FIG. 8C, an originating party 810 may convey indicia 820, 821, 822, 823 to a second party 830. Second party 830 may select one or more for purchase, receipt, or for transferring to another party. Similarly, FIG. 8D illustrates that an originating party 810 may convey more than one indicia 820, 821, 822, 823 to more than one party 830, 831, 832. For example, a teacher may pass on multiple indicia comprising a reading list to a variety of students.

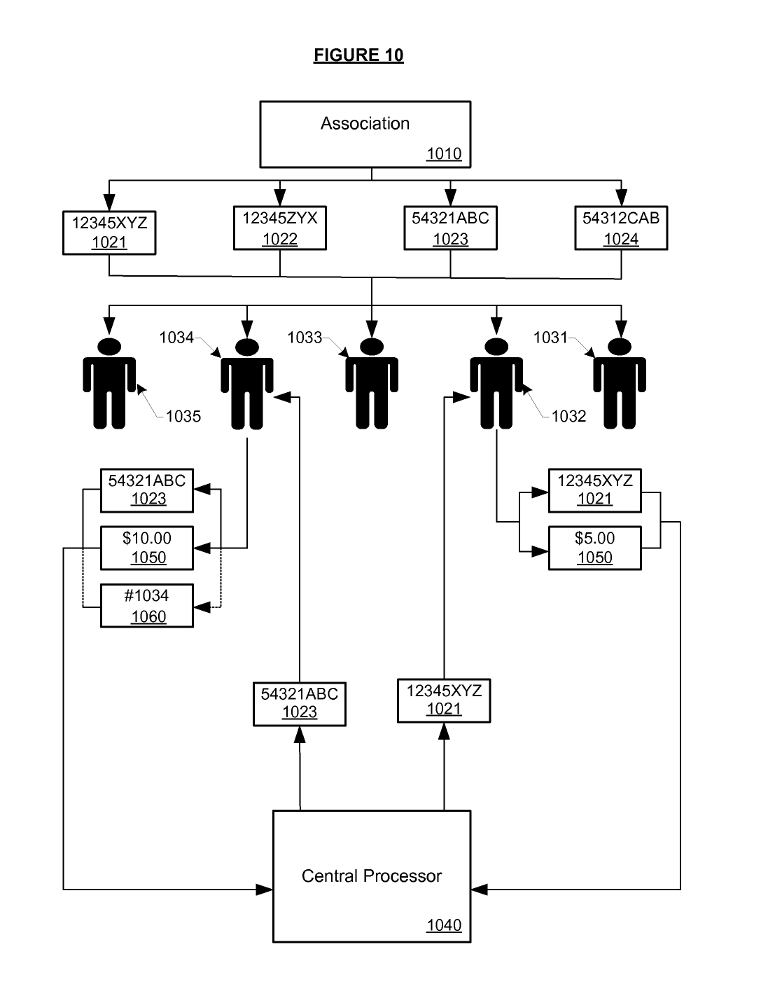

FIGS. 9A and 9B illustrate, in accordance with some embodiments of the present invention, that an indicia may identify a category or subset of goods or services and may evolve during transfers between various users to more specifically identify the specific goods or services. With reference to FIG. 9A, an originating party 910 may identify a general product that it wishes to receive or be sent to a receiving party. For example, originating party 910 may identify a pre-paid product line corresponding to value that can be used in a certain game. The originating party 910 may send an indicia 920A of this type of stored value card to second party 930. In this example, second party 930 may be the paying party; note, however, that it is anticipated that second party 930 may pass the indicia 920A further downstream, or may also be the receiving party.

Second party 930 may then determine what amount or level of value to be purchased. For example, an originating party 910 may have transferred an indicia related to tokens for use in GAME. Second party 930, as the paying party, may decide that he or she wishes to purchase ten dollars ($10.00) worth of tokens for use in GAME. Second party 930 may send the indicia 920A, an identification of the amount of value to be purchased 950, and the value 960 to a central processor 940, which may activate the indicia for use. The central processor 940 may then send the activated indicia—with a specific value—back to the second party 930, or to an identified receiving party. With reference to FIG. 9A, the receiving party may also be the originating party 910, and either the central processor 940 or the second party 930 may pass the activated, specific indicia 920B to the originating party 910 for use or further distribution.

With reference to FIG. 9B, another system and method in which an indicia may identify a category or subset of goods or services and may evolve during transfers between various users to more specifically identify the specific goods or services, in accordance with some embodiments of the present invention, will now be discussed.

In FIG. 9B, an originating user 910 may identify a category of goods or services and send an indicia of that category of goods or services to one or more second parties 930. For example, as depicted in FIG. 9B, an originating user 910 may send an indicia 920A that corresponds to a specific band, for example, the Beatles. Second party 930 may receive the indicia 920A and may select a specific good or service from the category sent. Second party 930 may then send the indicia 920A, an identification of selection 950—for example, the song “Yellow Submarine”—and value 960 to a central processor 940. The central processor 940 may activate the indicia for redemption or use with the specific goods or services selected by the second party 930. The central processor 940 may convey the activated specific indicia 920B back to the second party 930, or may convey the activated specific indicia 920B on to an identified receiving party. Note that while FIG. 9B depicts the originating party 910 as the receiving party, an additional or alternative receiving party may be present.

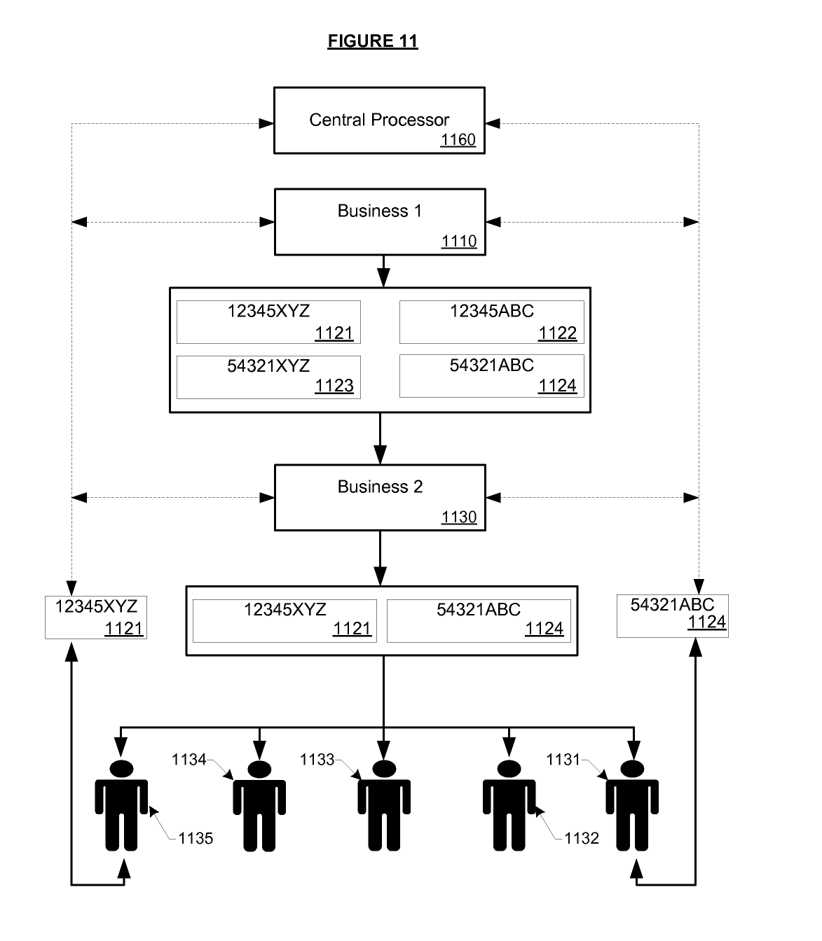

With reference to FIG. 10, in accordance with some embodiments of the present invention, an originating party 1010 may be an organization, association, partnership, or some other type of group or entity. For example, the originating party 1010 may be an association of like-minded members, such as, for example, an alumni organization from a university or college. The originating party 1010 may, through its status, be able to offer to its members certain goods and or services at a reduced rate. For example an alumni organization may offer various branded items (such as school sweatshirts, etc.) as well as publications written or performed by other alumni at a rate less expensive than publicly available. Originating party 1010 may convey one or more indicia 1021, 1022, 1023, 1024 to one or more members 1031, 1032, 1033, 1032, 1035. Some members may elect to purchase or otherwise obtain one or more goods or services identified by the indicia 1021, 1022, 1023, 1024, and may select such indicia 1021, 1022, 1023, 1024 and pass on the indicia, as well as value 1050 to a central processor 1040 for purchase.

Note that it is also contemplated that originating party 1010 may purchase each of goods or services identified by indicia 1021, 1022, 1023, 1024 for its members 1031, 1032, 1033, 1034, 1035, and members need only convey the indicia to the central processor 1040 for redemption.

The central processor 1040 may then provide—or initiate the provision of—the goods or services purchased to the receiving member (as depicted in FIG. 10, member 1032 may receive the goods or services identified by indicia 12345XYZ, and member 1034 may receive the goods or services identified by indicia 54321ABC).

Note that it is contemplated that in order to offer such reduced price offerings to members, the central processor may require identification of receiving party as a member of the association of the originating party 1010. For example, as illustrated in FIG. 10, a member 1034 may send an indicia of the selected goods or service 1023, as well as value 1050, and an identifying characteristic of the member 1060 to the central processor 1040. The central processor 1040 may then determine (a) the specific goods or services identified by the received indicia; (b) whether the amount of value received is appropriate for the specific goods or services identified by the received indicia; and (c) whether the requesting party is eligible, based upon an identifying characteristic, for the price or selection relevant to the specific goods or services identified by the received indicia.

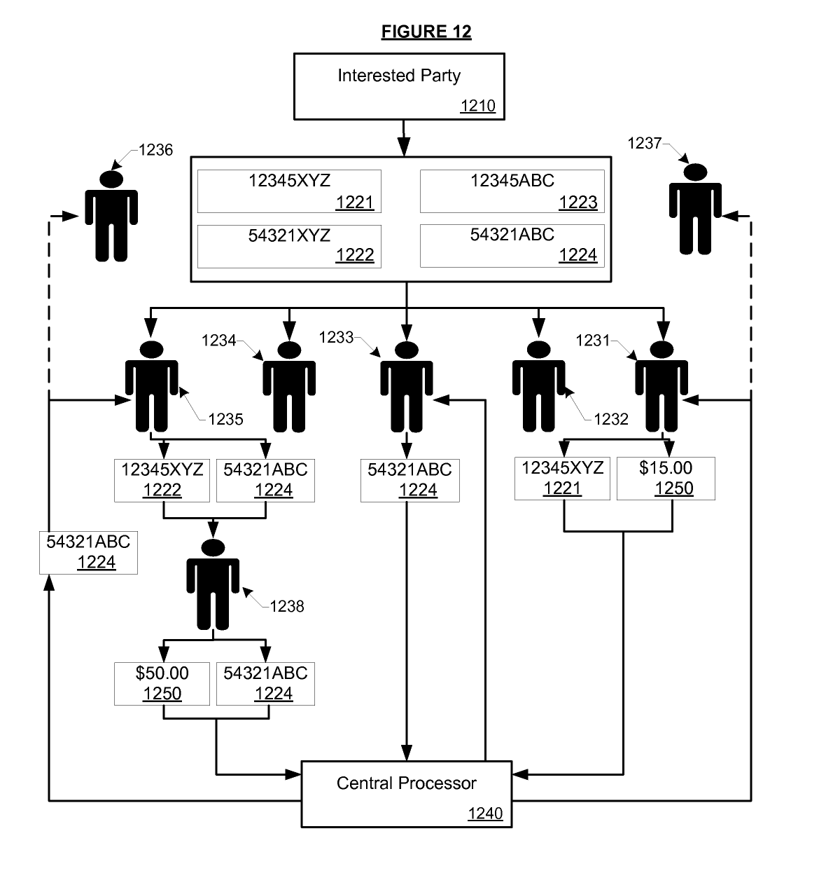

With reference to FIG. 11, systems and methods utilizing transferable indicia in accordance with the present invention may be utilized in business-to-business applications. For example, a first business 1110 may offer a selection of goods or services 1120 to a second business 1130. The selection of goods or services 1120 may comprise one or more indicia 1121, 1122, 1123, 1124 that identify or are associated with specific goods or services. Second business 1130 may then select one or more indicia from the selection of goods or services 1120, and may provide the indicia of such selected indicia to its employees and/or customers 1131, 1132, 1133, 1134, 1135. Employees and/or customers 1131, 1132, 1133, 1134, 1135 may select one or more of the indicia for redemption. It is contemplated that employees and/or customers 1131, 1132, 1133, 1134, 1135 may send the indicia back to second business 1130 at 1140 for redemption (and second business 1130 may aggregate the indicia received from its employees and/or customers and send the aggregate to the first business or to a central processor 1160), may send the indicia to the first business 1110 at 1150 for redemption (and the first business may send the indicia to the central processor 1160), or may send the indicia directly to the central processor 1160. The activated indicia or goods and services associated with the indicia may be provided to the employee and/or customer from the first business 1110, the second business 1130, or the central processor 1160.

Systems and methods in accordance with some embodiments of the present invention may also be used to convey specific goods or services—or to provide payment or value for specific goods or services—amongst specifically identified parties.

For example, certain goods or services may be identified as specifically desirable to provide to certain receiving parties. Certain goods and services, such as healthy food, warm clothes, tutoring, and specific extracurricular activities may be identified and grouped as desirable for children. Such grouping may be accomplished by a governmental entity or agency, a special interest group, or any other interested party. The grouping of specific goods and services may be distributed amongst various parties. Examples of this may include distributing such indicia to parents who pay child support, family members of at-risk or otherwise identified children, or to various charities and groups for external support (for example, an electronic version of a charity-driven gift exchange during the holiday season).

Specifically, an interested party 1210 may identify a group 1220 of one or more indicia 1221, 1222, 1223, 1224 determined to be of interest to, necessary, or desirable to provide to a receiving party. The group of indicia 1220 may be conveyed to one or more parties 1231, 1232, 1233, 1234, 1235. At this point, various processes may occur. For example, party 1231 may identify indicia 1221 as something that party 1231 would like to obtain for either itself, or for receiving party 1237. Party 1231 may then send indicia 1221 and payment 1250 to central processor 1240. Central processor 1240 may then determine the goods or service identified by indicia 1221 and provide, or initiate provision of, the goods or service either back to party 1231 or to receiving party 1237.

It is contemplated that in some circumstances, parties receiving the group of indicia may not have funds available for purchase of the identified goods or service, but may be entitled to the goods or services nonetheless. For example, user 1233 may identify indicia 1223 as being desirable and may send indicia 1223 alone to central processor 1240. Central processor 1240 may then provide, or initiate provision of, the goods or services back to party 1233. For example if party 1233 is on government assistance (food stamps, TANIF, etc.), certain additional goods or services may be provided free of charge.

In accordance with some embodiments, a user 1235 may receive the group of indicia 1220 and determine that from the group 1220, two identified goods or services are desirable.

The indicia associated with these goods or services 1222, 1224 may be conveyed to another party 1238 for purchase. Party 1238 may select one of the indicia sent 1224, and may convey the indicia 1224 and payment 1250 to the central processor 1240. The central processor may then provide, or initiate provision of the goods or services back to party 1235 or to an identified recipient 1236. For example, a state agency may determine what qualifies as “necessities” for children, and a custodial parent may send indicia corresponding to personally applicable necessities to a non-custodial parent (that is, one who is paying child support or otherwise providing financial assistance to the child or custodial parent). The non-custodial parent may then decide that he or she wishes (or may be obligated to some extent) to purchase a specific good or services (for example, school text books or supplies), and may send the indicia and payment to the central processor 1240. The central processor 1240 may then provide, or initiate provision of the goods or services to party 1235 or to receiving party (here, for example, the child) 1236.

In accordance with some embodiments of the present invention, an originating party 1310 may purchase or otherwise obtain a plurality of indicia 1321, 1322, 1323, 1324. Here, the originating party 1310 may also be the paying party. The originating party 1310 may then distribute the active indicia 1321, 1322, 1323, 1324 to various receiving parties 1331, 1332, 1333. Receiving party 1331 may receive indicia 1321; receiving party 1332 may receive indicia 1322 and 1323; receiving party 1333 may receive indicia 1324. Though the indicia 1321, 1322, 1323, 1324 may be paid for and active, they may not be redeemed yet. Accordingly, each of receiving parties 1331, 1332, 1333 may redeem their respective received indicia with a central processor 1340.

For example, at a holiday event an originating party may purchase a plurality of indicia and may distribute the indicia to receiving parties as the originating party sees fit. Another example may be the purchase of “digital stocking stuffers,” that an originating party can distribute amongst various gift recipients.

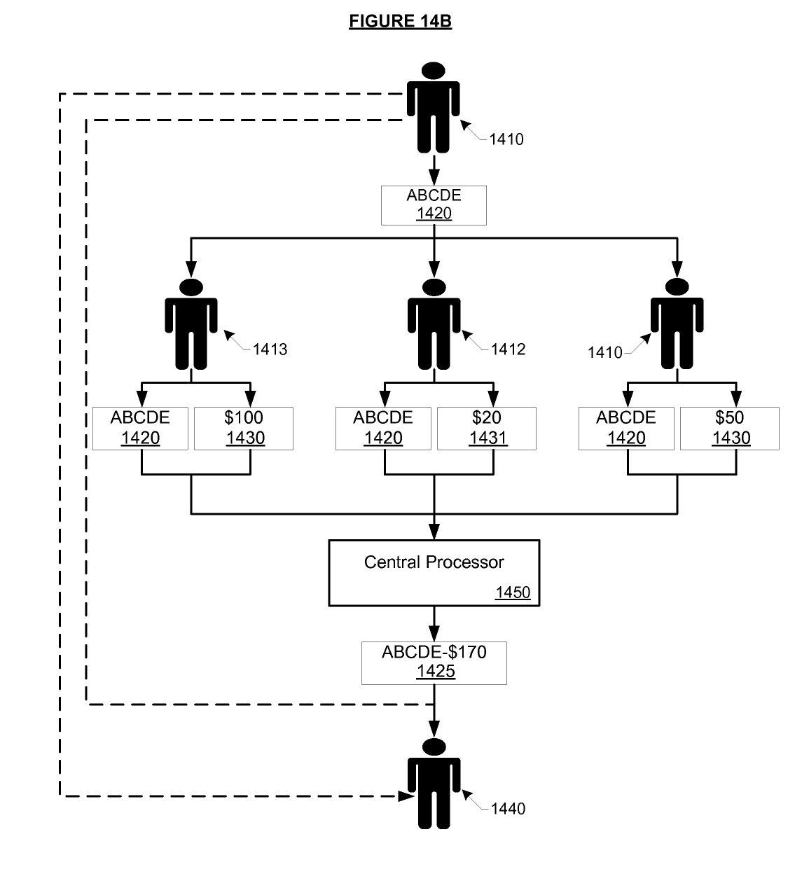

With reference to FIGS. 14A and 14B, systems and methods in accordance with some embodiments of the present invention directed to group gifting will now be discussed. Group gifting may generally be seen to occur in at least three (3) environments: a serial environment, a parallel environment, and/or a combination of the serial and parallel. With reference to FIG. 14A a serial environment will now be discussed.

An originating party 1410 may select an indicia corresponding to a good or service. For ease of discussion, the indicia may correspond to a prepaid debit or gift card. However, it is noted that group gifting may also provide different products or features of products that may be purchased or unlocked at various price points. Originating party 1410 may select indicia and may add value 1430 to the indicia. For example, originating party 1410 may add $50.00 to the indicia. The indicia 1420—with a value of $50.00—may then be conveyed to second party 1411. Second party 1411 may add $20.00 to the indicia, now indicia 1421 and convey indicia 1421 to third party 1412. Third party 141 may add $100.00 to the indicia. This process may continue through any number of parties. When the last party has added value (a party may be a last party when a pool of participating parties has been exhausted, when a time limit has been reached, or when there are no more parties interested in contributing to the gift), the final indicia 1422 with a combined value of $170.00 may be provided to receiving party 1440.

With reference to FIG. 14B, a parallel contribution schema will be discussed. In FIG. 14B, an originating user 1410 selects an indicia 1420 as a gift for receiving party 1440. Originating user 1410 then distributes the indicia 1420 to one or more parties 1411, 1412, 1413. Each of the one or more parties 1411, 1412, 1413 may add value to the indicia by conveying to a central processor the indicia 1420 and an amount of value. For example, party 1411 may value 1430 worth $50.00; party 1412 may convey value 1431 worth $20.00; party 1413 may convey value 1432 worth $100.00. The central processor 1450 may aggregate the value and provide an indicia 1425 that is associated with the combined gift value (here, $170.00). The central processor 1450 may provide the indicia to the receiving party 1440, or the central processor 1450 may provide the final funded indicia back to the originating party 1410 for conveyance to the receiving party 1440.

In general, the present invention provides indicia that are transferable a lifecycle of the indicia. The indicia may identify a certain good or service—or a group or set of goods or services. The indicia may be modified to further identify the good or service—for example, a specific song from a specified band, or a certain value on a gift card. The indicia may include identification of the originating party, receiving party, or paying party in order to provide for specific offers to groups of users. The indicia may include information identifying the originating merchant—if any—or any advertisements that lead an originating party to capture or otherwise record the indicia.

The indicia may be transferred amongst numerous parties in these various states. The indicia may evolve during such transferences to provide information necessary or desirable in a specific transaction.

Various other attributes and/or characteristics may be part of the system and method of the invention. For example, attributes such as a “daily deal” or other such name may be utilized. In such an attribute, a customer who downloads an indicia may receive a notice or message as part of the “daily deal” informing the customer of relevant, related promotions. For example, if a customer downloads an indicia for a restaurant (for example, an Outback gift card indicia), a movie theater indicia (for example, AMC theaters) may be provided at a discount because of, in light of, or based upon the desired restaurant purchase.

In accordance with some embodiments of the invention, an application or program as discussed above may be in selective communication with a retailer display when the user is in or near the retailer location (as opposed to requiring the user to be immediately next to or in a close proximity with the display). The application or program may then display either all or most virtual products available from the retailer.

In accordance with some embodiments of the invention, the application or program as discussed above may track the user's location, for example, within a retailer location. In this manner, detailed offers or “daily deals” may be offered to the user based upon the user's location within the location. For example, if the user is in the portion of the store where DVDs are sold, the user may receive a promotion or “daily deal” directed to, for example, a reduced price on a particular movie or theater tickets. Another example may be to offer a user a discount on complimentary items. For example is a user is in the portion of the store where computers are purchased, the user may receive a promotion or “daily deal” for online archival or back-up services.

It is also contemplated that various retailers and providers may intentionally reduce their potential commission in order to make a sale and be a providing retailer. For example, an originating retailer may advertise that if the purchase is made from the originating retailer, the price is 1.5% less than that which it would typically cost. The originating retailer—if it makes the sale and becomes the providing retailer, may be able to reduce its sales commission by the 1.5%, thereby collecting a full origination commission and a reduced sales commission in order to promote the sale.

Various other aspects of the invention may also be utilized. For example, when the indicia is obtained by a user device, in the case of digital goods or services, the goods or services may actually be placed on the device in a locked or inactive state. Once purchased—either in lane at the retailer or later through the use of an application or other connection, the digital goods or services may be unlocked. This may provide at least two (2) benefits.

First, the loading of the digital goods or services—which may require a fair amount of data to be transmitted—may be accomplished at the retailer, potentially using a free retailer-sponsored network connection. Accordingly, the user need not worry about excess data charges for such transfer. When the purchase is completed, a minimal amount of data may need to be transferred from the providing retailer to the receiving party in order to unlock or authorize the use of the digital goods or services. For example, an encryption key or other such password or authorization code may be transmitted from the providing party.

Second, a user may select various digital goods or services and load them onto a device, and then only select and pay for goods or services actually used. For example, prior to a trip a user may select three or four digital movies, indicia and files of which may be placed on the user device. The user may then select—and pay for—only the movies that it actually wants, or has time to watch.

Moreover, due to the transferability of the indicia (as discussed above), an originating party (e.g., a child) may send various indicia to another party (e.g., a parent) that the first party wants to access. The second party—the parent—may then select which goods or service it likes and pay for such goods and services, which may then be sent or provided to the originating party—or child. Such aspects may be coupled with what are commonly known as filter cards or restricted spend cards in order to provide value to a receiving party that has limitations in how it may be used (e.g., for groceries but not for alcohol or tobacco).

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

What is claimed is:

1. A method of conducting a transaction utilizing an indicia associated with goods or services, the indicia initially provided to an originating party by an originating merchant, but wherein the indicia may be used in a transaction at a providing merchant by an obtaining party, the transaction conducted amongst a central processor, one or more merchants that may include the originating merchant and the providing merchant, and one or more parties that may include the originating party and the obtaining party, the method comprising:
receiving at the central processor the indicia from the providing merchant;
determining by the central processor:
whether the indicia is valid; and
the goods or services associated with the indicia;
determining by the central processor whether the providing merchant is the originating merchant, and upon a determination that the providing merchant is not the originating merchant, determining an appropriate transaction price for the indicia;
determining by the central processor whether the obtaining party is the originating party, and upon a determination that the obtaining party is not the originating party, determining if the transaction price for the indicia should be modified;
communicating between the central processor and the providing merchant a final transaction price for the indicia.

2. The method of claim 1, further comprising activating the indicia at the central processor such that the indicia may be redeemed for the goods or services.

3. The method of claim 1, further comprising providing the goods or services to the obtaining party.

4. The method of claim 1, wherein the appropriate transaction price for the indicia is based at least in part upon any promotion applicable to the indicia offered by the originating merchant.

5. The method of claim 1, wherein the appropriate transaction price for the indicia is based at least in part upon any promotion applicable to the indicia offered by the providing merchant.

6. The method of claim 1, wherein the final transaction price for the indicia is based at least in part upon any promotion or special pricing applicable to the originating party.

7. The method of claim 1, wherein the final transaction price for the indicia is based at least in part upon any promotion or special pricing applicable to the obtaining party.

8. The method of claim 1, further comprising:
determining by the central processor whether the indicia has been transferred amongst multiple parties, and if so, recording the number of transfers.

9. The method of claim 8, wherein the determination of the central processor of whether the indicia has been transferred amongst multiple parties is based at least in part upon modifications or alterations to the indicia caused by such transfers.

10. The method of claim 1, wherein the determination of whether the providing merchant is the originating merchant is based at least in part upon a portion of indicia that identifies the originating merchant.

11. The method of claim 1, wherein the determination of whether the providing merchant is the originating merchant is based at least in part upon a comparison of the identity of the providing merchant with an identifier of the originating merchant, the identifier of the originating merchant being part of or included with the indicia.

12. The method of claim 1, wherein the determination by the central processor of whether the indicia is valid is based upon whether the indicia is an indicia representative of goods or services.

13. The method of claim 1, wherein the determination by the central processor of whether the indicia is valid is a determination of whether the indicia is acceptable by the providing merchant.

14. The method of claim 1, wherein the determination by the central processor of whether the indicia is valid is based upon whether a specified amount of time has expired, rendering the indicia invalid.

15. The method of claim 8, wherein the number of transfers are used to determine the popularity of goods or services, merchants, and/or promotions.

16. The method of claim 1, wherein the indicia is received at the central processor in an encrypted format.

17. A method of conducting a transaction utilizing an indicia associated with goods or services, the indicia initially provided to an originating party by an originating merchant, but wherein the indicia may be used in a transaction at a providing merchant by an obtaining party, the transaction conducted amongst a central processor, one or more merchants that may include the originating merchant and the providing merchant, and one or more parties that may include the originating party and the obtaining party, the method comprising:
receiving at the central processor an origination message comprising the indicia;
determining by the central processor:
whether the indicia is valid;
the goods or services associated with the indicia;
the originating merchant; and
any relevant price or promotion associated with the goods or services or originating merchant;
receiving at the central processor the indicia from the providing merchant;
determining by the central processor whether the providing merchant is the originating merchant, and upon a determination that the providing merchant is not the originating merchant, determining an appropriate transaction price for the indicia;
determining by the central processor whether the obtaining party is the originating party, and upon a determination that the obtaining party is not the originating party, determining if the transaction price for the indicia should be modified;
communicating between the central processor and the providing merchant a final transaction price for the goods or services associated with the indicia.

18. The method of claim 17, wherein the central processor receives the origination message from the originating merchant.

19. The method of claim 17, wherein the central processor receives the origination message from a display presented by the originating merchant.

20. The method of claim 17, wherein the central processor receives the origination message from a program or application associated with the originating merchant.

21. The method of claim 17, wherein the central processor receives the origination message from an electronic, digital, or online presence of the originating merchant.

22. The method of claim 17 wherein the central processor receives the origination message and the indicia in an encrypted communication.

23. The method of claim 17, wherein the origination message further comprises a time and date stamp of when the indicia was obtained from the originating merchant by the originating party.

24. A system for conducting a transaction utilizing an indicia associated with goods or services, the system comprising:
a central processor;
an originating merchant, the originating merchant providing the indicia to an originating party;
an originating party, the originating party obtaining the indicia from the originating merchant;
a providing merchant, the providing merchant providing either an activated indicia or the goods or services associated with the indicia to the obtaining party, the providing merchant being in selective communication with the central processor;
an obtaining party, the obtaining party conducting the transaction with the providing merchant and obtaining either an activated indicia or the goods or services from the providing merchant.

25. The system of claim 24, wherein the originating merchant and the providing merchant are the same merchant.

26. The system of claim 24, wherein the originating party and the obtaining party are the same party.

27. The system of claim 24, wherein the obtaining party receives an activated indicia from the providing merchant, and conveys the activated indicia to a receiving party.

28. The system of claim 24, wherein the central processor is configured to determine:
whether the indicia is valid;
the goods or services associated with the indicia;
whether the providing merchant is the originating merchant;
whether the obtaining party is the originating party; and
a final transaction price for the indicia.
